(19) United States
(12) Patent Application Publication
(10) Pub. No.: US 2012/0314897 A1
(43) Pub. Date: Dec. 13, 2012

(54) METHOD AND APPARATUS FOR HIGH SPEED DIGITAL COMMUNICATION USING 5-POLE TERMINALS

(75) Inventor: Hyung-Keun SONG, Seoul (KR)

(73) Assignee: SAMSUNG ELECTRONICS CO., LTD., Gyeonggi-Do (KR)

(21) Appl. No.: 13/493,046

(22) Filed: Jun. 11, 2012

(30) Foreign Application Priority Data
Jun. 13, 2011 (KR) 10-2011-0056796

(51) Int. Cl. H04R 1/10; H01R 13/64

(52) U.S. Cl. 381/384; 439/677

(57) ABSTRACT

An ear plug apparatus using a 5-pole connection terminal is provided. The apparatus includes an ear plug and at least one connection terminal. The at least one connection terminal is attached to the ear plug. At least one connection terminal is positioned at an end of a body of the ear plug and isolates a space between one connection terminal and another connection terminal and includes at least one insulation pad attached to the ear plug.

### CLAIM OF PRIORITY

This application claims the benefit of priority under 35 U.S.C. §119(a) from a Korean patent application filed in the Korean Intellectual Property Office on Jun. 13, 2011 and assigned Serial No. 10-2011-0056796, the entire disclosure of which is hereby incorporated by reference in its entirety.

### BACKGROUND OF THE INVENTION

1. Field of the Invention

The present invention relates to a method and an apparatus for an ear plug used for portable devices such as mobile phones, MP3 players, etc.

2. Description of the Related Art

As miniaturization and design of mobile apparatuses become more advanced, a great deal of effort has been made to reduce the size of a jack used for an external interface. For example, an iPod shuffle® uses an American type O-pole connection terminal ear plug (i.e. “four-pole plug”) so that it may use an audio interface and a high speed digital interface (Universal Serial Bus (USB)) in one unit.

In case of the American type 4-pole connection terminal ear plug, another connection terminal besides an L-R-GND, which is a traditional audio line, is used for an extra purpose (microphone or detect). In addition, for USB communication, four connection terminals are used for DM-DP-GND-VBUS. The DP denotes D+ and the DM denotes D-.

In other words, one ear plug is used for both USB communication and audio output, so that advantages in aspects of miniaturization and design have been achieved, but a non-standard plug (4-pole ear plug and ear jack) is used and so has a structure vulnerable to USB signal quality and Electro Magnetic Compatibility (EMC).

Therefore, companies use various methods for preventing Electro Magnetic Interference (EMI) radiation to an ear plug.

For example, a method for inserting an EMI filter for reducing EMI below an ear plug is frequently used. However, this method has problems associated with having to provide an EMI filter in a small form for being inserted into an ear plug, and with a high level of complexity in design and high costs.

Alternatively to the method for inserting an EMI filter, a method is frequently used for attaching a shield can (or tape) for preventing radiation to an ear plug side in order to prevent EMI radiation is frequently used.

This shield can attachment method can be processed at low costs, but an interval with a fourth terminal (Vbus, power) should be maintained in a structural aspect of an American type 4-pole terminal ear plug and a degree of EMI radiation prevention is determined depending on the interval, thereby making it difficult to output a constant result.

Therefore, a need in the art exists for a method and apparatus for high speed digital communication using 5 pole-terminals.

### SUMMARY OF THE INVENTION

An aspect of the present invention is to address at least some of the above-mentioned problems and/or disadvantages and to provide at least the advantages described below.

Accordingly, an exemplary aspect of the present invention is to provide a method and an apparatus for high speed digital communication using a 5-pole connection terminal.

Another exemplary aspect of the present invention is to provide a method and an apparatus for high speed digital communication using a 5-pole connection terminal to which an additional function is allocable by adding polarity to the structure and the size of an ear plug that now uses the conventional 4-pole connection terminal.

Still another exemplary aspect of the present invention is to provide a method and an apparatus for high speed digital communication using a 5-pole connection terminal, capable of easily applying an EMI shield to an ear plug that uses the conventional 4-pole connection terminal.

In accordance with another exemplary aspect of the present invention, an ear plug apparatus using a 5-pole connection terminal is provided. The apparatus preferably includes an ear plug having a body, and at least one connection terminal attached to the ear plug, wherein the at least one connection terminal is positioned at an end of a body of the ear plug, isolates a space between one connection terminal and another connection terminal and includes at least one insulation pad attached to the ear plug.

In accordance with another exemplary aspect of the present invention, an apparatus of a mobile terminal that uses a 5-pole connection terminal is provided. The apparatus preferably includes a modem for communicating with a different(another) node, a controller that when detecting that a predetermined connection terminal is used, controls using the predetermined connection terminal for signal transfer purposes, and at least one connection terminal comprising the predetermined connection terminal, wherein the predetermined connection terminal is positioned at an end of a body of an ear plug and includes the ear plug having at least one insulation pad isolating a space between the at least one connection terminal.

In accordance with still another exemplary aspect of the present invention, a method for operating a mobile terminal that uses a 5-pole connection terminal is provided. The method preferably includes determining whether a predetermined connection terminal is used, and when the predetermined connection terminal is used, utilizing the predetermined connection terminal for signal transfer purposes, wherein the predetermined connection terminal is included in an ear plug having at least one connection terminal including the predetermined connection terminal, and the predetermined connection terminal is positioned at an end of a body of the ear plug and includes at least one insulation pad isolating a space between the at least one connection terminal.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will be more apparent from the following description taken in conjunction with the accompanying drawings in which:

FIGS. 1A and 1B are illustrations of an ear plug and a configuration table according to an exemplary embodiment of the present invention;

FIG. 2 is a view illustrating an inner structure of an ear plug according to an exemplary embodiment of the present invention;

FIG. 3 is a flowchart illustrating an exemplary process for operating a mobile terminal that uses an ear plug according to an exemplary embodiment of the present invention; and

FIG. 4 is a block diagram illustrating a mobile terminal that uses an ear plug according to an exemplary embodiment of the present invention.

Throughout the drawings, like reference numerals will be understood to refer to like parts, components and structures.

### DETAILED DESCRIPTION

The following description with reference to the accompanying drawings is provided to assist a person of ordinary skill in the art in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments of the claimed invention described herein can be made without departing from the scope and spirit of the claimed invention. Also, descriptions of well-known functions and constructions may be omitted for clarity and conciseness when their inclusion may obscure appreciation of the present invention by the person of ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustrative purposes only and not for the purpose of limiting the present invention as defined by the appended claims and their equivalents.

It is also to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill those of ordinary skill in the art, may occur in amounts that do not preclude the effect the characteristic was intended to provide.

The present invention relates to a method and an apparatus for an ear plug using a 5-pole connection terminal that improves the conventional ear plug use a 4-pole connection terminal.

Exemplary embodiments of the present invention provide a method and an apparatus for high speed digital communication that uses a 5-pole connection terminal shown and described in the examples below in more detail.

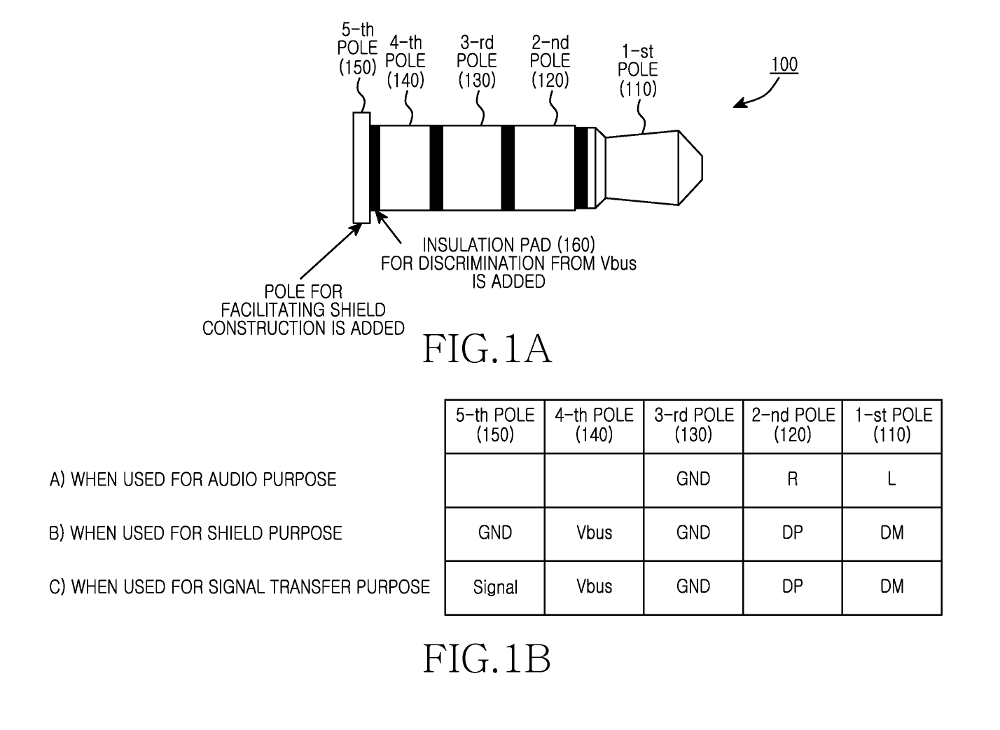

FIG. 1 is a view illustrating an ear plug according to an exemplary embodiment of the present invention.

Referring now to FIG. 1A, a case of providing an ear plug 100 having a 5-pole connection terminal 110, 120, 130, 140, and 150 by adding an insulation pad 160 to an ear plug having the conventional 4-pole connection terminal 110, 120, 130, and 140 is illustrated.

As shown in the example in FIG. 1A, the ear plug 100 having the 5-pole connection terminal according to an exemplary embodiment of the present invention is formed by adding a connection terminal (5-th pole 150) for facilitating shield construction. The 5-th connection terminal adds an insulation pad for discrimination from Vbus. The 5-th connection terminal is positioned at the end of a body of an ear plug connector and has substantially the same size or circumference as the end of the body.

When the ear plug having the 5-th connection terminal is used for an audio purpose (step (a) of FIG. 1B)), the first pole connection terminal 110 is used for a left signal L, a second pole connection terminal 120 is used for a right signal R, and a third pole connection terminal 130 is used for ground (GND).

When the ear plug having the 5-th connection terminal uses the 5-pole connection terminal for a shield purpose (step (b) of FIG. 1B), the first pole connection terminal 110 is used for a data signal DM, the second pole connection terminal 120 is used for a data signal DP, the third pole connection terminal 130 is used for GND, a fourth pole connection terminal 140 is used for power Vbus, and a fifth pole connection terminal 150 is used for GND. In this case, the fifth pole connection terminal 150 inside the ear plug is connected to the third pole connection terminal 130.

When the ear plug having the 5-th connection terminal uses the fifth pole connection terminal for signal transfer purpose between one device and another device using the ear plug. (step c of FIG. 1B), the first pole connection terminal 110 is used for a data signal (DM), the second pole connection terminal 120 is used for another data signal DP, the third pole connection terminal 130 is used for GND, the fourth pole connection terminal 140 is used for power Vbus, and the fifth pole connection terminal 150 is used for a signal.

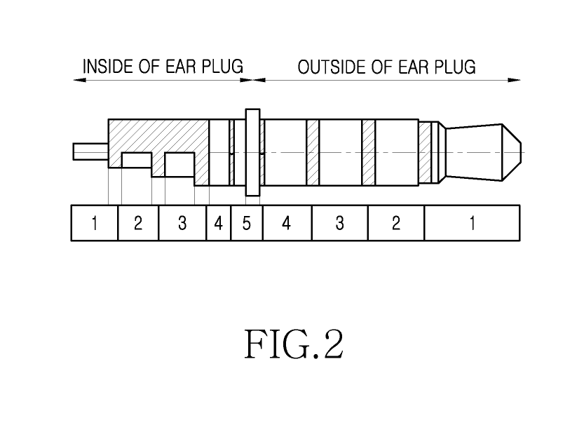

FIG. 2 is a view illustrating an inner structure of an ear plug according to an exemplary embodiment of the present invention.

Referring now to FIG. 2, the present invention may easily use a shield by connecting a 5-th pole connection terminal separated from a 4-th pole connection terminal to a ground terminal In this case, the 5-th pole connection terminal inside the ear plug is connected to a 3-rd pole connection terminal This connection with the 3-rd pole does not need to maintain an interval and so has an advantage of realizing constant EMI radiation characteristic.

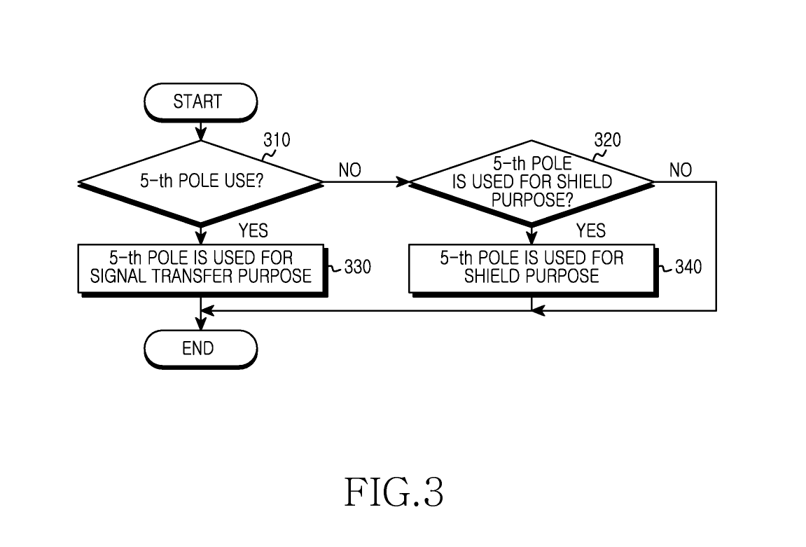

FIG. 3 is a flowchart illustrating a process for operating a mobile terminal that uses an ear plug according to an exemplary embodiment of the present invention.

Referring now to FIG. 3, in the case of a 5-th pole connection terminal (step 310), the mobile terminal uses the 5-th pole connection terminal for a signal transfer purpose (step 330).

In case of using the 5-th pole connection terminal for a shield purpose (step 320), the mobile terminal uses the 5-th pole connection terminal, that is, the 5-th connection terminal for shield, that is, ground (step 340).

In case of receiving a signal via the 5-th connection terminal, the mobile terminal recognizes whether the connection that uses the 5-th pole is being utilized, and whether the 5-th connection terminal is being used for signal transfer purposes.

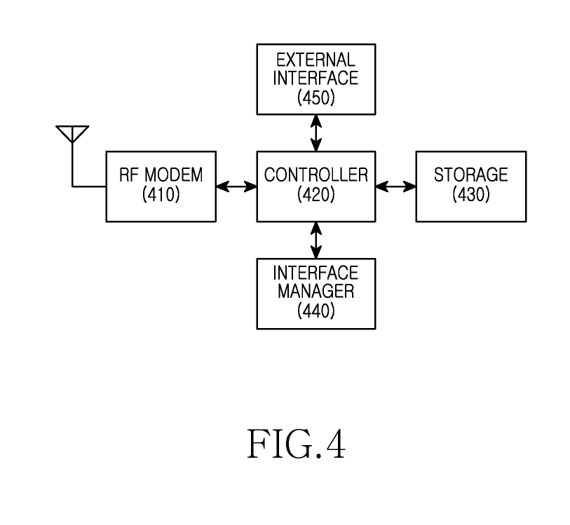

FIG. 4 is a block diagram illustrating an exemplary configuration of a mobile terminal that uses an ear plug according to an exemplary embodiment of the present invention.

Referring now to FIG. 4, the mobile terminal preferably includes a Radio Frequency (RF) modem 410, a controller 420, a storage 430, an interface manager 440, and an external interface 450. The controller 420, which may comprise a processor or microprocessor, may control or include the interface manager 440.

The RF modem 410 serves as a module for communicating with other apparatuses, and preferably includes a radio processor and a baseband processor. The radio processor converts a signal received via an antenna to a baseband signal and provides the same to the baseband processor, and converts a baseband signal from the baseband processor to an RF signal so that it may be transmitted on an actual radio path and transmits the same via the antenna.

The controller 420 controls an overall operation of the mobile terminal, and more particularly, controls the interface manager 440 according to an exemplary embodiment of the present invention.

The storage 430, which comprises a non-transitory machine readable medium, stores a program for controlling an overall operation of the mobile terminal and stores temporary data generated during execution of a program. In case of using a 5-th connection terminal, the interface manager 440 uses the 5-th pole connection terminal, that is, the 5-th connection terminal for signal transfer purpose. However, in case of using the 5-th pole connection terminal for shield purpose, the interface manager 440 uses the 5-th pole connection terminal, that is, the 5-th connection terminal for shield purpose, that is, ground GND.

In case of receiving a signal via the 5-th connection terminal, the interface manager 440 recognizes that connection that uses the 5-th pole is used, and uses the 5-th connection terminal for signal transfer purposes. In other words, in case of receiving a signal via the 5-th connection terminal of the ear jack, the interface manager 440 recognizes that connection that uses the 5-th pole is used, and uses the 5-th connection terminal for signal transfer purposes.

The external interface 450 has a 5-th ear jack that can recognize the 5-th pole ear plug of the present invention. A USB interface may be used as the external interface 450.

It will be appreciated that exemplary embodiments of the present invention according to the claims and description in the specification can be realized in the form of hardware, software or a combination of hardware and software. Any such software may be stored in a computer readable storage medium. The computer readable storage medium stores one or more programs (software modules), the one or more programs comprising instructions, which when executed by one or more processors in an electronic device, cause the electronic device to perform a method of the present invention.

In addition, such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, exemplary embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

The present invention may facilitate shield by connecting the 5-th pole connection terminal separated from the conventional 4-th pole connection terminal to a ground GND, and does not need to maintain an interval, so that constant EMI radiation characteristic may be realized.

In addition, the present invention has an advantageously of allocates an additional function by adding a pole using the conventional ear plug structure and size without modification.

The above-described methods according to the present invention can be implemented in hardware, firmware or as software or computer code that can be stored in a recording medium such as a CD ROM, an RAM, a floppy disk, a hard disk, thumbnail drive or a magneto-optical disk or computer code downloaded over a network originally stored on a remote recording medium or a non-transitory machine readable medium and to be stored on a local non-transitory recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An ear plug apparatus using a 5-pole connection terminal, the apparatus comprising:
an ear plug having five poles arranged along a body; and
at least one connection terminal attached to the ear plug,
wherein said at least one connection terminal is positioned at an end of the body of the ear plug and isolates a space between one connection terminal and another connection terminal and comprises at least one insulation pad attached to the ear plug.

2. The apparatus of claim 1, wherein the 5-pole connection terminal utilizes three poles when providing audio.

3. The apparatus of claim 1, wherein the 5-pole connection terminal utilizes five poles when providing shielding, two of which are ground.

4. The apparatus of claim 1, wherein the 5-pole connection terminal utilizes five poles when providing signal transfer.

5. The apparatus of claim 1, wherein the 5-pole connection terminal comprises the following configurations for audio, shielding and signal transfer:

| | 5-th Pole | 4-th Pole | 3-rd Pole | 2-nd Pole | 1-st Pole |
|---|---|---|---|---|---|
| AUDIO | | | GND | R | L |
| SHIELD | GND | Vbus | GND | DP | DM |
| SIGNAL | SIGNAL | Vbus | GND | DP | DM |
| TRANSFER | | | | | |

wherein “GND” is ground, “R” is right, “L” is left. “Vbus” is bus voltage, “DM” is D− and “DP” is D+.

6. The apparatus of claim 1, wherein said at least one connection terminal is connected to a ground terminal.

7. The apparatus of claim 1, wherein said at least one connection terminal provides signal transfer.

8. The apparatus of claim 1, wherein the ear plug apparatus provides a Universal Serial Bus (USB) interface.

9. An apparatus of a mobile terminal having a 5-pole connection terminal, comprising:
a modem for communicating with a different node; and
a controller that detects when a predetermined connection terminal is used for signal transfer,
wherein the predetermined connection terminal is positioned at an end of a body of an ear plug, and wherein the ear plug has at least one insulation pad isolating a space between one connection terminal and another connection terminal.

10. The apparatus of claim 9, wherein when the predetermined connection terminal of the ear plug is not operated for signal transfer, the predetermined connection terminal is connected to a ground terminal.

11. The apparatus of claim 9, wherein the ear plug is adapted for operation as an interface with a Universal Serial Bus (USB).

12. A method for operating a mobile terminal that uses a 5-pole connection terminal, the method comprising:
determining by a controller whether a predetermined connection terminal is included in an ear plug having at least one connection terminal is operating; and
when the controller determines the predetermined connection terminal is operating, using the predetermined connection terminal for signal transfer,
wherein the predetermined connection terminal is positioned at an end of a body of the ear plug and includes at least one insulation pad isolating a space between one connection terminal and another connection terminal.

13. The method of claim 12, wherein when the predetermined connection terminal of the ear plug is not operating for signal transfers, the predetermined connection terminal is connected to a ground terminal.

14. The method of claim 12, wherein the ear plug is operating as a Universal Serial Bus (USB) interface.
